(19) United States
(12) Patent Application Publication
(10) Pub. No.: US 2014/0278097 A1
(43) Pub. Date: Sep. 18, 2014

(54) SYSTEMS AND METHODS FOR GUIDANCE

(71) Applicants: Mohammad Suleiman KHORSHEED, Riyadh (SA); Hussein Khalid AL-OMARI, Amman (JO)

(72) Inventors: Mohammad Suleiman KHORSHEED, Riyadh (SA); Hussein Khalid AL-OMARI, Amman (JO)

(21) Appl. No.: 14/189,143

(22) Filed: Feb. 25, 2014

Related U.S. Application Data
(60) Provisional application No. 61/779,819, filed on Mar. 13, 2013.

(51) Int. Cl. G01C 21/34

(52) U.S. Cl. CPC G01C 21/34
USPC 701/533

(57) ABSTRACT

Systems and methods for indoor or outdoor environment guidance using mobile applications and communication devices. More specifically, a method implemented in a computer infrastructure is provided for having computer executable code tangibly embodied on a computer readable storage medium having programming instructions operable to: receive at least one indicia at a particular location; obtain information about the particular location from the scanned at least one indicia; generate route information to at least one destination location from the particular location using the obtained information; and overlay the route information on a map.

### FIELD OF THE INVENTION

The invention relates to location and/or guidance systems, applications and methods of implementation and, more particularly, to systems and methods for indoor or outdoor environment guidance using mobile applications and communication devices.

### BACKGROUND

Visitors of large indoor facilities (e.g., shopping malls) often have difficulty navigating and locating desired locations. The use of interactive displays designed to help visitors find their destination may be expensive, confusing, and time consuming for the visitor Likewise, existing location global navigation satellite systems or global positioning systems (GPS) are not suitable to determine indoor locations because microwaves are interfered with by indoor structures such as walls, roofs, and other objections in and around the building. More specifically, the satellite based GPS loses significant power indoors due to the signal attenuation caused by construction materials, which affects the required coverage for receivers by satellites.

### SUMMARY

In a first aspect of the invention, a method implemented in a computer infrastructure is provided for having computer executable code tangibly embodied on a computer readable storage medium having programming instructions operable to: receive at least one indicia at a particular location; obtain information about the particular location from the scanned at least one indicia; generate route information to at least one destination location from the particular location using the obtained information; and overlay the route information on a map.

In another aspect of the invention, a mobile application implemented on a hardware device is operable to: obtain location information from at least one indicia relating to a particular location of a facility where the at least one indicia is located; generate route information to at least one destination location from the particular location; and overlay the route information on a map.

In a further aspect of the invention, system comprising a CPU, a computer readable memory and a computer readable storage medium. Additionally, the system includes one or more program instructions to: receive at least one indicia at a particular location; decode information from the indicia about the particular location; overlay the information on a map; generate route information to at least one destination location from the particular location using the decoded information; and overlay the route information by providing a series of points from the particular location to the at least one destination location on the map.

### BRIEF DESCRIPTION OF THE DRAWINGS

The present invention is described in the detailed description which follows, in reference to the noted plurality of drawings by way of non-limiting examples of exemplary embodiments of the present invention.

FIG. 1 shows an illustrative environment for managing the processes in accordance with the invention;

FIG. 2 shows a mobile communication device in a representative setting in accordance with aspects of the present invention;

FIG. 3 shows a representation of the mobile communication device obtaining location and other information in accordance with aspects of the present invention;

FIG. 4 is a representative screen view of a mobile communication device in accordance with aspects of the present invention; and

FIGS. 5 and 6 show exemplary flows in accordance with aspects of the invention.

### DETAILED DESCRIPTION OF THE INVENTION

The invention relates to location and/or guidance systems, applications and methods of implementation and, more particularly, to systems and methods for indoor or outdoor environment guidance using mobile applications. In particular embodiments, the systems and methods of the present invention assist any person with a mobile communication device, e.g., a smart phone or other communication device, to find their way in an indoor or outdoor environment without the need for GPS. In embodiments, the systems and methods of the present invention enable the user to determine their location and, in embodiments, route information, within such environments using a mobile application.

By way of example, the systems and methods of the present invention may provide a map of an indoor environment or facility, e.g., store, shopping mall, hospital, office complex, parking lots, hotels and supermarkets, etc., or outdoor environment or facility, e.g., sports complex, amusement parks, etc., on a mobile communication device and, using the map, apprise the user of their current location. In additional or alternative embodiments, the systems and methods of the present invention may direct the user to specific locations within the facility using the user's current location as a beginning point. In embodiments, the user's current location may be determined by scanning, reading or otherwise recognizing encoded indicia at predetermined locations within the facility, where each encoded indicia includes at least information of its current location.

The encoded indicia can be, for example, one or two dimensional (1D/2D) barcodes (as shown in FIG. 3); although other methods are also contemplated by the present invention. For example, in contemplated aspects of the present invention, the encoded indicia can include signs, color codes, writings, etc., which can be scanned, read or otherwise recognized by the mobile communication device by, e.g., optical character recognition systems, bar code readers, or even speech recognition software, all of which are known to those of skill in the art. The encoded indicia can be decoded by the mobile communication device to determine the user's current location, and then overlaid onto a map of the facility.

In implementation, the encoded indicia can be placed at different locations throughout the facility including, for example, at the entryway and strategically placed locations throughout the facility, e.g., locations well traversed, locations of known interest, locations deemed to have importance, etc. For example, signs or other indicia with the encoded information may be drawn, posted or stuck on the ground, wall, at an information desk, on posters (which can also be used for marketing and promotion purposes) or other locations throughout the facility, e.g., entranceway to attractions at an amusement park, museum, etc. As an example, the indicia can be placed at an ingress and egress of doorways, hallways, or at any decision point, e.g., each corner, turn, hallway, etc. The system may also be mounted or installed on a mobile robot which then acts as indoor guidance for elderly people or people with special needs. For example, the robot may assist users by providing mobile assistance, auditory instruction, or by acting as a guide.

The encoded indicia can be decoded by the mobile communication device and overlaid onto a map of the facility to inform the user of his/her current location. The map may be obtained by the user as they are entering the facility, e.g., uploaded by the mobile communication device using the decoded information of the indicia. In other embodiments, the map can be provided by a mobile application, uploaded at the user's request. In other embodiments, the map can be provided by the facility, or a third party service provider, by accessing a website, for example. The map can be stored in the mobile communication device, for later retrieval. In this latter scenario, the map can be automatically called by the mobile device, at the bequest of the user or by the mobile communication device recognizing its location by scanning, reading and/or recognizing information on the indicia.

### System Environment

The present invention may be embodied as a system, method or computer program product. The present invention may take the form of a hardware embodiment, a software embodiment or a combination of software and hardware. Furthermore, the present invention may take the form of a computer program product embodied in any tangible storage having computer-usable program code embodied in the medium (non-transitory medium). The computer-usable or computer-readable medium may be any medium that can contain, store, or communicate, for use by or in connection with the instruction execution system, apparatus, or device. The computer-usable or computer-readable medium may be, for example, an electronic, magnetic, optical, electromagnetic, infrared, or semiconductor system, apparatus, or device.

Any combination of one or more computer readable medium(s) may be utilized. More specific examples of the computer readable storage medium, memory or device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium, memory or device, or computer-usable or computer-readable medium, as used herein, is not to be construed as being transitory signals per se.

FIG. 1 shows an illustrative environment 10 for managing the processes in accordance with the invention. The environment 10 includes a server or other computing system 12 that can perform the processes described herein. In embodiments, the illustrative environment may be used to implement a mobile application, providing the features and functionality and combination thereof, presented herein. The computing system 12 includes a computing device 14 which can be resident on or communicate with a network infrastructure or other computing devices such as, for example, web applications. In embodiments, the computing system 12 can be a mobile communication device such as a cellular telephone with the functionality described herein.

The computing device 14 includes a processor 20, memory 22A, an I/O interface 24, and a bus 26. In addition, the computing device includes random access memory (RAM), a read-only memory (ROM), and an operating system (O/S). The computing device 14 is in communication with the external I/O device/resource 28 and the storage system 22B. The I/O device 28 can comprise any device that enables an individual to interact with the computing device 14 (e.g., user interface) or any device that enables the computing device 14 to communicate with one or more other computing devices using any type of communications link.

The processor 20 executes computer program code (e.g., program control 44), which can be stored in the memory 22A and/or storage system 22B. While executing the computer program code, the processor 20 can read and/or write data to/from memory 22A, storage system 22B, and/or I/O interface 24. The program code executes the processes of the invention such as, for example, reading, scanning or otherwise recognizing indicia or speech to determine a current location of the user.

The computing device 14 includes a recognition module 105, a map module 110, and a direction module 115. The recognition module 105, map module 110, and direction module 115 can be implemented as one or more program code in the program control 44 stored in memory 22A as separate or combined modules. Additionally, recognition module 105, map module 110, and direction module 115 may be implemented as separate dedicated processors or a single or several processors to provide the function of these tools. Moreover, it should be understood by those of ordinary skill in the art that the recognition module 105, map module 110, and direction module 115 are used as general descriptive terms for providing the features and/or functions of the present invention, and that the recognition module 105, map module 110, and direction module 115 may comprise many different components such as, for example, the components and/or infrastructure described and shown with reference to FIG. 2. The recognition module 105, map module 110, and direction module 115 can be implemented in a mobile communication device as a standalone application (which may be representative of the computing system 12 of FIG. 1).

By way of illustrative non-limiting exemplary use, upon entering a facility, the recognition module 105 can read, scan, or otherwise recognize the encoded indicia (see, FIG. 3). The recognition module 105 can be, for example, a bar code reader, optical recognition system, speech recognition system, etc. The recognition module 105 may decode the indicia to provide such information to the map module 110. In embodiments, the encoded indicia at the entryway of a facility can include the name or other identification information of the facility. In this way, the mobile communication device, e.g., map module 110, can upload a map of the facility by, for example, communicating with a service provider, a web application, the facility, itself, or searching the memory/storage of the mobile communication device itself, in case the map has already been uploaded. The map module 110 can then overlay the current location of the user, e.g., mobile communication device, onto a map, such that the user can view their current location. In embodiments, the mobile communication device may use a voice system to inform the user of their current location.

The direction module 115 can use the current location information to provide a “roadmap”, e.g., directions, from the current location to a desired target destination requested by the user. In embodiments, the target location may be input by the user or uploaded from a service provider. For example, the user can scan item information at their residence (e.g., using information obtained from a retailer's website), in anticipation of a trip to a shopping mall. This item information can be, for example, a shopping list.

Upon arrival at the shopping mall, the user (mobile communication device) can scan or otherwise recognize indicia at the entryway, as implemented by the recognition module 105. The recognition module 105 will decode this information thereby determining the current location of the user and, in embodiments, pass this information to the map module 110 to obtain a map of the shopping mall (and any desired retailer located within the shopping mall). In the latter, the information can include specific facility information in order for the map module 110 to obtain the map of the facility. The current location will then be overlaid onto the map, using the map module 110.

The mobile communication device then uses the item information, previously obtained by the user, to determine the locations of the items within the retail store or other facility. This may be done by querying the retail environment while at the shopping mall or through the web application, e.g., query a website to overlay item location on the map. The direction module 115 then uses this information to provide directions to the user (see, e.g., FIG. 4).

Also, in further embodiments, the user can user the graphical interface of the mobile communication device 12 to request directions to a specific location. This can be accomplished through several mechanisms. For example, a drop down window, touch screen options or speech recognition can be provided on the mobile communication device in order for the user to enter such information, requesting directions to:

(i) a certain location within a retail environment,

(ii) a certain item within a retail environment,

(iii) a certain office or department within a building such as a doctor's office within a hospital as one example, and/or

(iv) the user's vehicle in a garage facility, etc.

The options, e.g., a drop down window, touch screen options, can be provided by a service provider, or uploaded directly from the facility. This may be accomplished using a web application, for example.

### Implementations

FIG. 2 shows a mobile communication device 12 in a representative setting in accordance with aspects of the present invention. More specifically, FIG. 2 shows the mobile communication device 12, a facility 120 with location information 130 (e.g., encoded indicia), and a web application or service provider 150. As should be understood by those of skill in the art, the functionality described herein may be provided as a mobile application, wherein the features of the present invention can be resident as a mobile application on the mobile communication device 12, retrieved from a network or other source, e.g., the indicia at a particular location, or any combinations thereof.

For example, the mobile communication device 12 (e.g., hardware device) can implement the mobile application such that it is operable to: obtain location information from at least one indicia relating to a particular location of a facility where the at least one indicia is located; generate route information to at least one destination location from the particular location; and overlay the route information on a map. The mobile application can obtain the map over a network or it can generate the map from the indicia, for example. The mobile application can display a series of points from the particular location to the at least one destination location on the map based on a calculated distance or arrival time.

In embodiments, the web application or service provider 150 can obtain information, including map information, item location, and other location or item information or the like directly from the facility 120 or other service provider. This information can be provided to the mobile communication device 12, in order to provide a map of the facility 120 as well as item or other location information associated with the map. The web application or service provider 150 or the mobile communication device 12 can use this information in order to provide the current location of the user, as well as route/direction information.

FIG. 3 shows a representation of the mobile communication device 12 obtaining location information, in accordance with aspects of the present invention. More specifically, as shown in FIG. 3, the mobile communication device 12 is placed near location information 130, which includes current location information, as well as other information as described herein. This other information can be, for example, facility identification, which can be used to retrieve a map from a mobile application or storage within the mobile communication device 12. Although one and two dimensional bar codes are shown, it should be understood that other encoded indicia is also contemplated by the present invention, as described herein.

FIG. 4 is a representative screen view 160 of a mobile communication device 12 in accordance with aspects of the present invention. This representative screen view 160 can be provided, in real time, on the mobile communication device 12 shown in FIG. 1. The representative screen view 160 can be representative of an online shopping experience, or other activity. In any scenario, the screen view shows a map 170 with directions 180. The map can be obtained from scanned or other recognized information at the facility, either uploaded or retrieved at arrival or prior to arrival. For example, the user can upload map information from a service provider or from a retailer of another facility. The map can then be stored on the mobile communication device and retrieved upon arrival at the facility, called up using the information obtained from the decoded information. This can be accomplished using a conventional database program, e.g., using hash tables 190, by comparing the location ID to the map.

### Illustrative Exemplary Uses

In an illustrative non-limiting example, the user may have an appointment with their doctor at a large medical facility. In this scenario, the user may upload a map of the medical facility, using a central service provider. Once the map is uploaded, the user can then enter doctor information, in order to obtain directions to the doctor's office, at arrival at the medical facility. Upon arrival at the medical facility, the user will scan encoded information at an entryway in order to obtain current location information. The current location information can then be overlaid onto the map, which was previously uploaded into the user's mobile communication device. The mobile communication device will then use the current location in order to determine and provide a route from the current location to the doctor's office, using well known algorithms, including shortest trip, fastest arrival time, etc.

Once at the doctor's office, the user may be informed that additional tests are needed, including, for example, an MRI and blood tests. Using a scroll down window with information uploaded from the service provider or hospital facility, using a web application, the user can then request directions to the MRI department and Phlebotonai st department. Knowing the user's current location, e.g., by recognizing encoded indicia at the doctor's office using the recognition module, the direction module will provide directions to both departments. The user can periodically scan indicia to determine their current location and, if necessary, the mobile communication device will update the current location and any necessary route information. This same process/procedure can be performed at any of the departments in order to provide further directions to other departments, etc. All of this can be provided without using a GPS.

In another example, a user may be attending an exhibition, in a large exhibition hall. Prior to arriving at the hall, the user may upload a map of the hall and have such map information stored on their mobile communication device. This map may include the layout of the exhibition hall, including, for example, the location of exhibitor's booths and information concerning the same, e.g., name of vendor, etc. As an alternative approach, the map can be uploaded at the user's arrival at the hall, using the processes described herein, e.g., by recognizing the encoded indicia (which includes map information, etc., and correlating such information with a map.

In any of these scenarios, the user may want to visit as many as exhibitors as possible. To do such planning, the user may select exhibitors of interest by using a scroll down window, touch screen of exhibitions, speech recognition, etc. The user may also select priorities, such as an order in which to see certain exhibitors, time of day, etc. Once the booths of each of the exhibitors are selected (with any other information), the systems and methods of the present invention can then prepare a route, based on technologies described herein. In embodiments, for example, the selected booths are overlaid onto the map, for viewing by the user.

At the exhibition hall, encoded indicia can be placed throughout, including, for example, at each of the exhibitor's booth as well as other strategic locations, e.g., restrooms, eateries, entryway, etc. The encoded indicia can be posters, signs, barcodes, etc. Once the user arrives at the exhibition, the mobile communication device of the user can recognize the encoded indicia, in order to provide a location of the user. This initial location can then be used to generate a route based on the information entered (selected) by the user. As the user traverses the exhibit hall, at any single point of time they can scan the encoded indicia in order to obtain location information. If the user goes off track, the systems and methods can merely recalculate current location information and use this current location information to provide an updated route map trip.

It should be understood by those of skill in the art that any combinations and scenarios of the examples provided herein are contemplated by the present invention. In addition, any combinations and scenarios of other examples, functions, etc., are also contemplated by the present invention.

### Processes of the Invention

FIGS. 5 and 6 are exemplary flowcharts that illustrate the architecture, functionality, and operation of possible implementations of systems, methods, and computer program products according to the present invention. In this regard, each block in the flowchart or block diagrams may represent a module, segment, or portion of instructions, which comprises one or more executable instructions for implementing the specified logical function(s). The module, segment, or portion of instructions can be implemented in the environment shown in FIG. 1, for example. Also, as noted above, the executable instructions can be implemented by special purpose hardware-based systems that perform the specified functions or acts or carry out combinations of special purpose hardware and computer instructions.

The steps of the flow diagrams may be implemented and executed from either a server, in a client server relationship, or they may run on a user workstation with operative information conveyed to the user workstation. Furthermore, the invention can take the form of a computer program product accessible from a computer-usable or computer-readable medium providing program code for use by or in connection with a computer or any instruction execution system. The software and/or computer program product can be implemented in the environment of FIGS. 1-3. The flows may implement any of the steps or functions as already described herein. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIG. 5 shows an exemplary flow for performing aspects of the present invention. The steps of FIG. 5 may be implemented in the environment of FIG. 1, for example. As noted above, the flowchart(s) illustrate the architecture, functionality, and operation of possible implementations of systems, methods, and computer program products according to various embodiments of the present invention. In embodiments, a process 200 is provided for obtaining a map and destination information.

At step 210, map information may be uploaded or retrieved by a mobile communication device of a user (i.e., a mobile communication device a user wants to use to navigate a facility). In embodiments, a user may request that the mobile communication device (e.g., mobile communication device 12 as shown in FIG. 4) upload or retrieve map information including a map of an indoor or outdoor facility (e.g., facility 130) as shown in FIG. 2. The map information may be uploaded or retrieved from the location information (e.g., the encoded indicia) and/or a web application (e.g., service provider 150 as shown in FIG. 2). The received map information may include a 2D/3D graphical map of the facility and additional information about the facility. For example, the additional information may include location information for various destinations in the facility (e.g., the locations for different storefronts or merchandise).

More specifically, in embodiments, the mobile communication device may be configured to use a map application (e.g., map module 110 as shown in FIG. 1) to send a request for the map information upon receiving user input or a command from the web application (e.g., entry into a facility may cause the web application to automatically send a command that requests the map application retrieve or upload map information regarding the facility). As should be understood by those of ordinary skill in the art, the command from the web application may be sent periodically, initiated manually, or initiated upon entering the facility (e.g., scanning the encoded indicia). The map application may respond to the map request and obtain the map information by communicating with a service provider, scanning a 1D/2D barcode, accessing the web application, retrieving from the facility, or by retrieving existing maps in the storage of the mobile communication device.

At step 220, destination information (e.g., mapping coordinated of a destination in a facility that a user wishes to achieve) may be received or obtained by the mobile communication device. In embodiments, a user may enter specific locations of interest contained within the indoor or outdoor facility (e.g., the location of different storefronts or merchandise). For example, the specific locations of interest may be entered in a graphical user interface (GUI), by a user, using a drop down window, touch screen options, or speech recognition. The destination information for the specific locations of interest may be received by the GUI on the mobile communication device, received as a result of a scan by the mobile communication device, received as part of the map information, or received from a service provider.

In embodiments, the destination information may be associated with item information that has been entered by the user (e.g., retail items). For example, the item information may be provided by a shopping list, items scanned by the user, items purchased by the user in the past, or items entered manually by the user. The item information may be received from the GUI on the mobile communication device. For example, the item information may be entered in the GUI, by a user, using a drop down window, touch screen options, or speech recognition. The destination information for the item information may be received from the GUI on the mobile communication device, received as a result of a scan by the mobile communication device, received as part of the map information, or received from a service provider.

At step 230, the received map information and destination information is stored to be used by the mobile communication device for further processing, as described in relation to FIG. 6. For example, the map information and destination information may be stored in the memory (e.g., memory 22A) of the mobile communication device. In embodiments, the map information and destination information may be stored remotely from the mobile communication device by the service provider. For example, the map information and destination information may be stored in a database, a cloud network, or another remote storage device of the user's choosing. In embodiments, the map information and destination information may be stored in combination such that the destination information corresponds to locations on the map. For example, the map information and destination information can be stored in a hash table (e.g., hash table 190 as shown in FIG. 4) which stores the destination information associated with location information on the map.

FIG. 6 depicts an exemplary flow for a process 300 of mapping a route in an indoor or outdoor facility in accordance with aspects of the present invention. At step 310, encoded indicia (e.g., indicia 130 as shown in FIG. 2) may be scanned, read, or recognized. For example, the mobile communication device may be used to scan, read, or recognize encoded indicia located within a facility (e.g., facility 120 as shown in FIG. 2). In embodiments, the encoded indicia may be a 1D/2D barcode, a sign, a color code, or writings which are machine recognizable. The scanning, reading, or recognizing may be performed by a recognition module (e.g., the recognition module 105 as shown in FIG. 1) of the mobile communication device. For example, the recognition module may scan, read, or recognize the encoded indicia using a bar code reader, optical recognition system, or speech recognition software.

At step 320, information may be decoded from the scanned, read, or recognized encoded indicia. For example, the mobile communication device may decode information from the scanned, read, or recognized encoded indicia. In embodiments, the decoded indicia may include information related to the map, the current location of the encoded indicia, the location of points of interest in the facility, or any other information about the facility that is included in the encoded indicia. For example, the map of the facility may be uploaded to the mobile communication device from the decoded indicia. In embodiments, the decoded indicia may include the entire map of the facility, a partial detailed map, information needed to obtain the map using the web application on the mobile communication device, or a combination of the above.

In embodiments, the decoded indicia may include information related to the user's current location. For example, the indicia may include the location of the encoded indicia that the mobile communication device has scanned (e.g., the location of a store or storefront scanned at the user's current location). In embodiments, the current location from the decoded indicia may be overlaid onto the map of the facility to show the user their current location. For example, a star icon may be placed on the map to indicate the user's current location. The decoded indicia and any other decoded information may be stored in the mobile communication device or passed on to a map module (e.g., the map module 110 as shown in FIG. 1) and subsequently to a direction module (e.g., the direction module 115 as shown in FIG. 1) for further processing as described in relation to steps 330 and 340 below.

At step 330, the map and destination information may be obtained or retrieved, as discussed with respect to FIG. 5. For example, the mobile communication device may obtain or retrieve the map and destination information. The map and destination information for the facility may be received from the decoded indicia. For example, the decoded indicia may include the map of the facility and information related to locations within the facility as described in step 320. In embodiments, previously stored map and destination information may be retrieved from storage of the mobile communication device. For example, the user may have uploaded the map and desired destination information using the map application prior to arriving at the facility. The received map and destination information may be may be provided to a direction module (e.g., the direction module 115 as shown in FIG. 1) for further processing.

At step 340, a route may be overlaid on the map. For example, the mobile communication device may use the received map and destination information to display a route on the map. In embodiments, the mobile communication device may calculate a route from the user's current location, determined from the decoded indicia, to one or more received destination locations. In embodiments, the map application of the mobile communication device may query the facility or the web application (e.g., service provider) for information related to the user selected locations. For example, the map application may query map information, item location, and other location information. The mobile communication device uses the current location of the user and the received and/or queried destination information to overlay a route on the map of the facility.

In embodiments, the overlay may be a separate layer that is applied over the map of the facility and may be applied without modifying the stored map. The overlay route may include a series of points between the user's current location and a particular destination location. For example, the overlaying may provide a line showing the user a path to take to arrive at the destination location. As should be understood by those of ordinary skill in the art, the series of points may include a dotted line, a solid line, or a line customizable by the user. In embodiments, the user may update their current location by scanning nearby encoded indicia. The direction module will update the path according the new decoded current location of the user.

In embodiments, a service provider, such as a Solution Integrator, could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

The foregoing examples have been provided for the purpose of explanation and should not be construed as limiting the present invention. While the present invention has been described with reference to an exemplary embodiment, Changes may be made, within the purview of the appended claims, without departing from the scope and spirit of the present invention in its aspects. Also, although the present invention has been described herein with reference to particular materials and embodiments, the present invention is not intended to be limited to the particulars disclosed herein; rather, the present invention extends to all functionally equivalent structures, methods and uses, such as are within the scope of the appended claims.

What is claimed is:

1. A method implemented in a computer infrastructure having computer executable code tangibly embodied on a computer readable storage medium having programming instructions operable to:
receive at least one indicia at a particular location;
obtain information about the particular location from the scanned at least one indicia;
generate route information to at least one destination location from the particular location using the obtained information; and
overlay the route information on a map.

2. The method of claim 1, wherein the receiving is obtained by at least one of an optical character recognition system, a bar code reader, and a speech recognition system.

3. The method of claim 1, wherein the at least one indicia is at least one of a 1D barcode, a 2D bar code, color codes, and writings.

4. The method of claim 3, wherein the at least one indicia is installed on at least one of a poster, information desk, and floor.

5. The method of claim 3, wherein the at least one indicia is installed on a mobile robot that is configured to provide guidance for the route information.

6. The method of claim 1, wherein the programming instructions are further operable to decode the information by relating the at least one indicia to the particular location on the map.

7. The method of claim 1, wherein the overlaying provides a route comprising a series of points to the at least one destination location.

8. The method of claim 1, wherein the programming instructions are further operable to automatically obtain the map upon entry into a facility.

9. The method of claim 1, wherein the programming instructions are further operable to retrieve the map from storage of a mobile device.

10. The method of claim 1, wherein the programming instructions are further operable to retrieve the map over a network.

11. The method of claim 1, wherein the programming instructions are further operable to receive the at least one destination location from a user and use the least one destination location to generate the route information and overlay the route information on the map.

12. The method of claim 1, wherein:
the route information further comprises an algorithm for calculating a shortest distance or a fastest arrival time, and
the overlaying comprises displaying a series of points from the particular location to the at least one destination location on the map based on the calculated shortest distance or the fastest arrival time.

13. The method of claim 1, wherein the route information further comprises a priority for the at least one destination location.

14. A mobile application implemented on a hardware device, operable to:
obtain location information from at least one indicia relating to a particular location of a facility where the at least one indicia is located;
generate route information to at least one destination location from the particular location; and
overlay the route information on a map.

15. The mobile application of claim 14, wherein the map is obtained over a network infrastructure.

16. The mobile application of claim 14, wherein the map is generated from the at least one indicia.

17. The mobile application of claim 14, wherein the map is obtained prior to obtaining the location information from the at least one indicia.

18. The mobile application of claim 14, wherein the overlaying comprises displaying a series of points from the particular location to the at least one destination location on the map based on a calculated distance or arrival time.

19. A system comprising:
a CPU, a computer readable memory and a computer readable storage medium;
program instructions to receive at least one indicia at a particular location;
program instructions to decode information from the indicia about the particular location;
program instructions to overlay the information on a map;
program instructions to generate route information to at least one destination location from the particular location using the decoded information; and
program instructions to overlay the route information by providing a series of points from the particular location to the at least one destination location on the map.

20. The system of claim 19, wherein the map is obtained from a networking infrastructure.
